(19) United States
(12) Patent Application Publication
(10) Pub. No.: US 2024/0204559 A1
(43) Pub. Date: Jun. 20, 2024

(54) EMERGENCY LAMP CONTROL CIRCUIT

(71) Applicant: Xiamen Topstar Lighting Co., Ltd., Xiamen (CN)

(72) Inventors: Yongjie WU, Xiamen (CN); Naijun YANG, Xiamen (CN)

(73) Assignee: Xiamen Topstar Lighting Co., Ltd., Xiamen (CN)

(21) Appl. No.: 18/592,105

(22) Filed: Feb. 29, 2024

(30) Foreign Application Priority Data
Feb. 2, 2024 (CN) 202420264421.4

(51) Int. Cl. H02J 9/02

(52) U.S. Cl. CPC H02J 9/02

(57) ABSTRACT

An emergency lamp control circuit includes a dimmer and an emergency detection module. The emergency detection module is connected in parallel to two ends of the dimmer, one end of the emergency detection module is connected to a live wire end of a mains supply, the other end is connected to one end of an emergency lamp, and the other end of the emergency lamp is connected to a null wire end of the mains supply. Then, a detection loop can be provided for the emergency lamp when the dimmer is powered off, so that a situation that the emergency lamp enters an emergency lighting state by mistake because voltages on the live wire end and the null wire end of the mains supply cannot be detected is avoided; and only when the power grid is powered off, the lamp smoothly enters the emergency lighting state.

### CROSS-REFERENCE TO RELATED APPLICATIONS

This application claims priority to Chinese Patent Application No. 202420264421.4, filed on Feb. 2, 2024, the content of which is incorporated herein by reference in its entirety.

### TECHNICAL FIELD

The present disclosure relates to the technical field of emergency lamps, in particular to an emergency lamp control circuit.

### BACKGROUND

An existing emergency lamp is incompatible with a dimmer, particularly, products belonging to downlamp series are basically used to cooperate with current situations of applications of the dimmer; the existing lamp is in the following two situations.

Once a live wire end and a null wire end of a mains supply are powered off, a lamp will enter an emergency lighting state: it is basically determined, by detecting whether there is power on the live wire end and the null wire end of the mains supply, whether the existing emergency lamp enters the emergency lighting state, once the live wire end and the null wire end of the mains supply are powered off, the lamp will enter the emergency lighting state, and the dimmer is connected in series to the live wire end of the mains supply, and once the dimmer is turned off, the lamp product will enter an emergency state to light due to misjudgment, which is undesired by a user.

Due to the combination that the live wire end and the null wire end of the mains supply are powered off and it is determined that impedance values of power grid coils on the live wire end and the null wire end of the mains supply are within a certain range (<500 KΩ), the lamp enters the emergency lighting state: on a circuit where the dimmer is additionally provided, when the dimmer is in a turned-off state, once the power is cut off, impedances on the live wire end and the null wire end of the mains supply will become an MΩ level due to the blocking of the dimmer, which cannot satisfy the requirement that the lamp enters the required emergency lighting state by detecting impedance match conditions of the power grid coils on the live wire end and the null wire end of the mains supply.

### SUMMARY

The technical problem to be solved in the present disclosure is to provide an emergency lamp control circuit by which an emergency lamp is well compatible with a dimmer, and an emergency lamp connected with a dimmer loop can automatically determine whether to enter an emergency lighting state according to a determination whether there is power on a power grid.

In order to solve the above-mentioned technical problem, the present disclosure adopts the technical solution as follows.

Provided is an emergency lamp control circuit, including a dimmer and an emergency detection module, the emergency detection module being connected in parallel to two ends of the dimmer, one end of the emergency detection module connected to the dimmer being connected to a live wire end of a mains supply, the other end of the emergency detection module connected to the dimmer being electrically connected to one end of an emergency lamp, and the other end of the emergency lamp being connected to a null wire end of the mains supply.

The present disclosure has the beneficial effects that: in the present solution, the emergency detection module is connected in parallel to two ends of the dimmer, and the module can provide a detection loop for the emergency lamp when the dimmer is turned off, so that a situation that the emergency lamp used in combination with the dimmer enters an emergency lighting state by mistake because voltages on the live wire end and the null wire end of the mains supply cannot be detected is avoided; in such a design case, if a power grid (the mains supply) is powered off, no electric signals can be detected on the emergency lamp connected to a dimmer loop, and thus, the lamp smoothly enters the emergency lighting state; in such a way, the emergency lamp is well compatible with the dimmer, and the emergency lamp connected with the dimmer loop can automatically determine whether to enter the emergency lighting state according to a determination whether there is power on the power grid.

### BRIEF DESCRIPTION OF THE DRAWINGS

FIG. 1 is a connection block diagram of an emergency lamp control circuit according to the present disclosure.

FIG. 2 is a first schematic circuit diagram of an emergency detection module of the emergency lamp control circuit according to the present disclosure.

FIG. 3 is a second schematic circuit diagram of the emergency detection module of the emergency lamp control circuit according to the present disclosure.

FIG. 4 is a third schematic circuit diagram of the emergency detection module of the emergency lamp control circuit according to the present disclosure.

### DETAILED DESCRIPTION OF THE EMBODIMENTS

In order to describe the technical content as well as achieved objects and effects of the present disclosure in detail, the following description will be shown in conjunction with implementations and cooperation with the accompanying drawings.

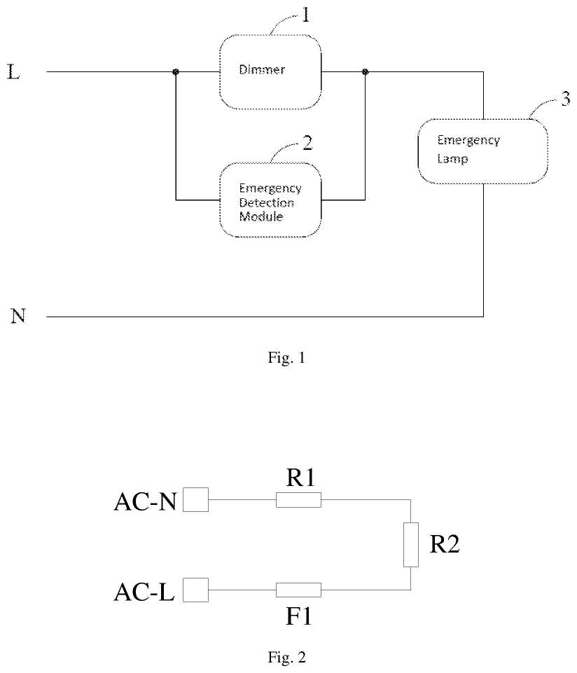

Refer to FIG. 1, the present disclosure adopts the technical solution.

Provided is an emergency lamp control circuit, including a dimmer and an emergency detection module, the emergency detection module being connected in parallel to two ends of the dimmer, one end of the emergency detection module connected to the dimmer being connected to a live wire end of a mains supply, the other end of the emergency detection module connected to the dimmer being electrically connected to one end of an emergency lamp, and the other end of the emergency lamp being connected to a null wire end of the mains supply.

It can be known from above description that the present disclosure has the following beneficial effects.

In the present solution, the emergency detection module is connected in parallel to two ends of the dimmer, and the module can provide a detection loop for the emergency lamp when the dimmer is turned off, so that a situation that the emergency lamp used in combination with the dimmer enters an emergency lighting state by mistake because voltages on the live wire end and the null wire end of the mains supply cannot be detected is avoided; in such a design case, if a power grid (the mains supply) is powered off, no electric signals can be detected on the emergency lamp connected to a dimmer loop, and thus, the lamp smoothly enters the emergency lighting state; in such a way, the emergency lamp is well compatible with the dimmer, and the emergency lamp connected with the dimmer loop can automatically determine whether to enter the emergency lighting state according to a determination whether there is power on the power grid.

Further, the emergency detection module includes a resistor R1, a resistor R2, and a fuse resistor F1, one end of the fuse resistor F1 is electrically connected to one end of the dimmer and the live wire end of the mains supply, the other end of the fuse resistor F1 is electrically connected to one end of the resistor R2, the other end of the resistor R2 is electrically connected to one end of the resistor R1, and the other end of the resistor R1 is electrically connected to the other end of the dimmer and one end of the emergency lamp, respectively.

It can be known from above description that the resistor R1 and the resistor R2 play a role in limiting a current, and the fuse resistor F1 plays a role in cutoff for overcurrent protection of other devices; and when the dimmer is turned off, the power grid can provide a current loop through the fuse resistor F1, the resistor R1, and the resistor R2, the current of such a loop is too small to light the emergency lamp, however, a voltage signal can be provided for the emergency lamp, so that the emergency lamp determines that the live wire end and the null wire end of the mains supply are in a non-power-off state at the moment.

Further, a resistance value of the resistor R1 is equal to a resistance value of the resistor R2.

Further, the emergency detection module includes a resistor R3, a capacitor C1, and a fuse resistor F2, one end of the fuse resistor F2 is electrically connected to one end of the dimmer and the live wire end of the mains supply, the other end of the fuse resistor F2 is electrically connected to one end of the resistor R3, the other end of the resistor R3 is electrically connected to one end of the capacitor C1, and the other end of the capacitor C1 is electrically connected to the other end of the dimmer and one end of the emergency lamp, respectively.

It can be known from above description that the resistor R3 and the capacitor C1 are combined to play a role in limiting a current, and the fuse resistor F1 plays a role in cutoff for overcurrent protection of other devices; and when the dimmer is turned off, the power grid can provide a current loop through the resistor R3, the capacitor C1, and the fuse resistor F2, the current of such a loop is too small to light the emergency lamp, however, a voltage signal can be provided for the emergency lamp, so that the emergency lamp determines that the live wire end and the null wire end of the mains supply are in a non-power-off state at the moment.

Further, the emergency detection module includes a resistor R4, a resistor R5, a fuse resistor F3, a rectifier bridge BD1, and an MOS transistor Q1, a source electrode of the MOS transistor Q1 is grounded, a drain electrode of the MOS transistor Q1 is electrically connected to one end of the resistor R5, the other end of the resistor R5 is electrically connected to one end of the resistor R4, the other end of the resistor R4 is electrically connected to a third end of the rectifier bridge BD1, a first end of the rectifier bridge BD1 is electrically connected to one end of the fuse resistor F3, the other end of the fuse resistor F3 is electrically connected to one end of the dimmer and the live wire end of the mains supply, a second end of the rectifier bridge BD1 is electrically connected to the other end of the dimmer and the emergency lamp, respectively, and a fourth end of the rectifier bridge BD1 is grounded.

It can be known from above description that when the dimmer is turned off, the power grid can provide a current loop through the fuse resistor F3, the rectifier bridge BD1, the resistor R4, the resistor R5, and the MOS transistor Q1, the current of such a loop is too small to light the emergency lamp, however, a voltage signal can be provided for the emergency lamp, so that the emergency lamp determines that the live wire end and the null wire end of the mains supply are in a non-power-off state at the moment. The resistor R4 and the resistor R5 play a role in limiting a current of the loop, the fuse resistor R3 plays a role in overcurrent protection for the overall module, the rectifier bridge BD1 converts an alternating current into a direct current, the MOS transistor Q1 provides a main loop for the emergency detection module and functions as a switch; when the emergency lamp is not connected, the MOS transistor Q1 is turned off due to loop disconnection, and thus, a lampholder is prevented from being electrified; when the emergency lamp is connected, the source electrode of the MOS transistor Q1 has a low potential which will turn on the MOS transistor Q1, and the emergency detection module can provide the voltage signal for the emergency lamp.

Further, a resistance value of the resistor R4 is equal to a resistance value of the resistor R5.

Further, the emergency detection module further includes a resistor R6 and a resistor R7, one end of the resistor R6 is electrically connected to the other end of the resistor R4 and the third end of the rectifier bridge BD1, respectively, the other end of the resistor R6 is electrically connected to one end of the resistor R7, and the other end of the resistor R7 is electrically connected to a grid electrode of the MOS transistor Q1.

It can be known from above description that the resistor R6 and the resistor R7 are disposed to provide a voltage loop for the grid electrode of the MOS transistor Q1.

Further, the emergency detection module further includes an electrolytic capacitor E1, one end of the electrolytic capacitor E1 is electrically connected to the other end of the resistor R4 and the third end of the rectifier bridge BD1, respectively, the other end of the electrolytic capacitor E1 is electrically connected to the source electrode of the MOS transistor Q1, and the other end of the electrolytic capacitor E1 is grounded.

It can be known from above description that the electrolytic capacitor E1 is disposed to provide a stable voltage signal for a loop, so that it is ensured that the MOS transistor Q1 can be continuously turned on.

Refer to FIG. 1 to FIG. 4, embodiment 1 of the present disclosure is described as follows.

Refer to FIG. 1, provided is an emergency lamp control circuit, including a dimmer 1 and an emergency detection module 2, the emergency detection module 2 being connected in parallel to two ends of the dimmer 1, one end of the emergency detection module 2 connected to the dimmer 1 being connected to a live wire end of a mains supply, the other end of the emergency detection module 2 connected to the dimmer 1 being electrically connected to one end of an emergency lamp 3, and the other end of the emergency lamp 3 being connected to a null wire end of the mains supply.

Refer to FIG. 2, the emergency detection module 2 includes a resistor R1, a resistor R2, and a fuse resistor F1 (of which a resistance value is 0Ω-100Ω), one end of the fuse resistor F1 is electrically connected to one end of the dimmer 1 and the live wire end of the mains supply, the other end of the fuse resistor F1 is electrically connected to one end of the resistor R2, the other end of the resistor R2 is electrically connected to one end of the resistor R1, and the other end of the resistor R1 is electrically connected to the other end of the dimmer 1 and one end of the emergency lamp 3, respectively.

A resistance value of the resistor R1 is equal to a resistance value of the resistor R2, and they are both 2.5 MΩ.

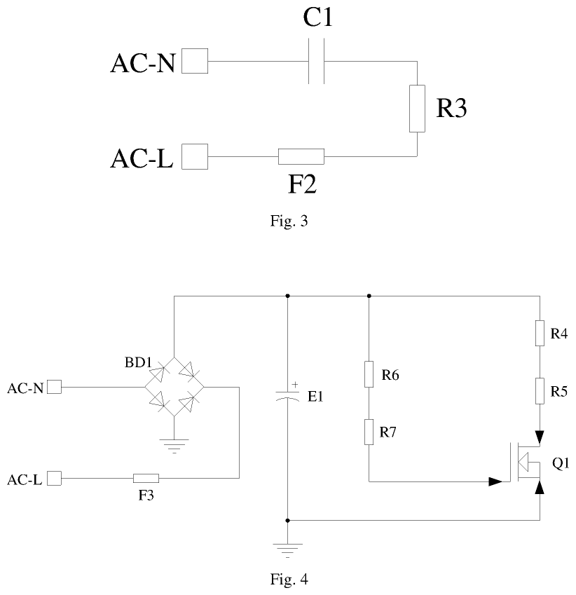

Refer to FIG. 3, the emergency detection module 2 includes a resistor R3 (of which a resistance value is 2.5 MΩ), a capacitor C1 (of which a capacitance value is InF), and a fuse resistor F2 (of which a resistance value is 0Ω-100Ω), one end of the fuse resistor F2 is electrically connected to one end of the dimmer 1 and the live wire end of the mains supply, the other end of the fuse resistor F2 is electrically connected to one end of the resistor R3, the other end of the resistor R3 is electrically connected to one end of the capacitor C1, and the other end of the capacitor C1 is electrically connected to the other end of the dimmer 1 and one end of the emergency lamp 3, respectively.

Refer to FIG. 4, the emergency detection module 2 includes a resistor R4, a resistor R5, a fuse resistor F3 (of which a resistance value is 0Ω-100Ω), a rectifier bridge BD1 (of which a working current is 0.5 A-2 A, and a working voltage is 200 V-1500 V), and an MOS transistor Q1 (of which a working current is 0.1 A-4 A, and a working voltage is 200 V-1500 V), a source electrode of the MOS transistor Q1 is grounded, a drain electrode of the MOS transistor Q1 is electrically connected to one end of the resistor R5, the other end of the resistor R5 is electrically connected to one end of the resistor R4, the other end of the resistor R4 is electrically connected to a third end of the rectifier bridge BD1, a first end of the rectifier bridge BD1 is electrically connected to one end of the fuse resistor F3, the other end of the fuse resistor F3 is electrically connected to one end of the dimmer 1 and the live wire end of the mains supply, a second end of the rectifier bridge BD1 is electrically connected to the other end of the dimmer 1 and the emergency lamp 3, respectively, and a fourth end of the rectifier bridge BD1 is grounded.

A resistance value of the resistor R4 is equal to a resistance value of the resistor R5, and they are both 2 MΩ.

Refer to FIG. 4, the emergency detection module 2 further includes a resistor R6 (of which a resistance value is 2.5 MΩ) and a resistor R7 (of which a resistance value is 2.5 MΩ), one end of the resistor R6 is electrically connected to the other end of the resistor R4 and the third end of the rectifier bridge BD1, respectively, the other end of the resistor R6 is electrically connected to one end of the resistor R7, and the other end of the resistor R7 is electrically connected to a grid electrode of the MOS transistor Q1.

Refer to FIG. 4, the emergency detection module 2 further includes an electrolytic capacitor E1, one end of the electrolytic capacitor E1 is electrically connected to the other end of the resistor R4 and the third end of the rectifier bridge BD1, respectively, the other end of the electrolytic capacitor E1 is electrically connected to the source electrode of the MOS transistor Q1, and the other end of the electrolytic capacitor E1 is grounded.

In conclusion, the present disclosure provides the emergency lamp control circuit. The emergency detection module is connected in parallel to two ends of the dimmer, and the module can provide a detection loop for the emergency lamp when the dimmer is turned off, so that a situation that the emergency lamp used in combination with the dimmer enters an emergency lighting state by mistake because voltages on the live wire end and the null wire end of the mains supply cannot be detected is avoided; in such a design case, if a power grid (the mains supply) is powered off, no electric signals can be detected on the emergency lamp connected to a dimmer loop, and thus, the lamp smoothly enters the emergency lighting state; in such a way, the emergency lamp is well compatible with the dimmer, and the emergency lamp connected with the dimmer loop can automatically determine whether to enter the emergency lighting state according to a determination whether there is power on the power grid.

Above descriptions are merely embodiments of the present disclosure, and are not intended to hence limit the patent scope of the present disclosure. Any equivalent transformations made according to the contents of the description and the accompanying drawings of the present disclosure are directly or indirectly applied to the related art and also fall within the patent protection scope of the present disclosure in a similar way.

What is claimed is:

1. An emergency lamp control circuit, comprising a dimmer and an emergency detection module, the emergency detection module being connected in parallel to two ends of the dimmer, one end of the emergency detection module connected to the dimmer being connected to a live wire end of a mains supply, the other end of the emergency detection module connected to the dimmer being electrically connected to one end of an emergency lamp, and the other end of the emergency lamp being connected to a null wire end of the mains supply.

2. The emergency lamp control circuit according to claim 1, wherein the emergency detection module comprises a first resistor, a second resistor, and a first fuse resistor, one end of the first fuse resistor is electrically connected to one end of the dimmer and the live wire end of the mains supply, the other end of the first fuse resistor is electrically connected to one end of the second resistor, the other end of the second resistor is electrically connected to one end of the first resistor, and the other end of the first resistor is electrically connected to the other end of the dimmer and one end of the emergency lamp, respectively.

3. The emergency lamp control circuit according to claim 2, wherein a resistance value of the first resistor is equal to a resistance value of the second resistor.

4. The emergency lamp control circuit according to claim 1, wherein the emergency detection module comprises a third resistor, a first capacitor, and a second fuse resistor, one end of the second fuse resistor is electrically connected to one end of the dimmer and the live wire end of the mains supply, the other end of the second fuse resistor is electrically connected to one end of the third resistor, the other end of the third resistor is electrically connected to one end of the first capacitor, and the other end of the first capacitor is electrically connected to the other end of the dimmer and one end of the emergency lamp, respectively.

5. The emergency lamp control circuit according to claim 1, wherein the emergency detection module comprises a fourth resistor, a fifth resistor, a third fuse resistor, a first rectifier bridge, and an first MOS transistor, a source electrode of the first MOS transistor is grounded, a drain electrode of the first MOS transistor is electrically connected to one end of the fifth resistor, the other end of the fifth resistor is electrically connected to one end of the fourth resistor, the other end of the fourth resistor is electrically connected to a third end of the first rectifier bridge, a first end of the first rectifier bridge is electrically connected to one end of the third fuse resistor, the other end of the third fuse resistor is electrically connected to one end of the dimmer and the live wire end of the mains supply, a second end of the first rectifier bridge is electrically connected to the other end of the dimmer and the emergency lamp, respectively, and a fourth end of the first rectifier bridge is grounded.

6. The emergency lamp control circuit according to claim 5, wherein a resistance value of the fourth resistor is equal to a resistance value of the fifth resistor.

7. The emergency lamp control circuit according to claim 5, wherein the emergency detection module further comprises a sixth resistor and a seventh resistor, one end of the sixth resistor is electrically connected to the other end of the fourth resistor and the third end of the first rectifier bridge, respectively, the other end of the sixth resistor is electrically connected to one end of the seventh resistor, and the other end of the seventh resistor is electrically connected to a grid electrode of the first MOS transistor.

8. The emergency lamp control circuit according to claim 5, wherein the emergency detection module further comprises an first electrolytic capacitor, one end of the first electrolytic capacitor is electrically connected to the other end of the fourth resistor and the third end of the first rectifier bridge, respectively, the other end of the first electrolytic capacitor is electrically connected to the source electrode of the first MOS transistor, and the other end of the first electrolytic capacitor is grounded.
